(19) United States
(12) Patent Application Publication
(10) Pub. No.: US 2019/0113089 A1
(43) Pub. Date: Apr. 18, 2019

(54) Reinforcing Rib Type Barbed Backing Plate of Brake Pad

(71) Applicant: Guangdong Junhui Automotive Technologies Co., Ltd., Guangzhou (CN)

(72) Inventor: Jinbin Xie, Guangzhou (CN)

(21) Appl. No.: 15/730,762

(22) Filed: Oct. 12, 2017

(51) Int. Cl. F16D 65/097; F16D 69/04

(52) U.S. Cl. CPC F16D 65/0972; F16D 2065/1332; F16D 69/04

(57) ABSTRACT

A reinforcing rib type barbed backing plate of brake pad, comprising a main body, wherein the upper surface of the main body is provided with inclined upward barbs connected with friction material, and the inclination of the barbs is less than 90°. The inner side of the root of the barbs inclines and extends downwards to form grooves lower than the upper surface, and the bottom of the groove inclines upward in the opposite side of the barbs for transition to intersect with the upper surface. The Invention can effectively increase the strength of the backing plate of brake pad, adhesion of friction material and brake performance of the brake pad.

### TECHNICAL FIELD

The Invention relates to the field of brake parts, in particular to a reinforcing rib type barbed backing plate of brake pad.

### BACKGROUND ART

The brake pad comprises such main parts as backing plate and friction material, and other auxiliary parts, i.e. the backing plate serves as a part of the brake pad, and is mainly used for fixing purpose. In the manufacturing process, the powdery friction material is (mostly) rolled and integrated on the backing plate through chemical and physical actions under high temperature and high pressure. Sometimes, a bedding layer is added between the backing plate and friction material, not for friction action but for noise reduction, heat insulation, and buffer action (fixing). In the braking process, a friction force is produced by means of applying pressure between the fixed brake pad and brake disc rotating with the wheel to achieve braking effect. The friction force is produced from a friction action between friction material and brake disc. In the friction action, one force is to stop the rotation of wheels for braking, and its opposite force acts on the car to produce a torque. The opposite force is transferred onto the car via the backing plate (through braking caliper), i.e. fixing for force transfer.

So far, the technology in the field is to increase adhesion strength by means of punching many process holes on the backing plate of brake pad. Nevertheless, it is difficult to ensure the precision of backing plate in this case, and distortion is likely to occur, further affecting the planeness of the backing plate; if less process holes are punched, insufficient adhesion strength is produced between backing plate and friction material, resulting in potential safety hazards during braking due to insufficient adhesion and friction force.

### SUMMARY OF THE INVENTION

The technical problem to be solved by the Invention is to provide a reinforcing rib type barbed backing plate of brake pad which can effectively ensure strength of backing plate and increase adhesion strength of the friction material.

The technical scheme of the Invention to solve the above technical problem is as follows:

A reinforcing rib type barbed backing plate of brake pad, comprising a main body, wherein the upper surface of the main body is provided with inclined upward barbs connected with friction material, and the inclination of the barbs is less than 90°.

Preferably, the inner side of the root of the barbs inclines and extends downwards to form grooves lower than the upper surface, and the bottom of the grooves inclines upward in the opposite side of the barbs for transition to intersect with the upper surface.

Preferably, both sides of the root of the barbs are provided with reinforcing ribs connected with the upper surface.

Preferably, inclination direction of the rows of the barks varies with that of the individual barbs. Moreover, the rows of the barks are set at intervals and alternately in inclination direction.

Preferably, the barbs are spaced evenly along the width direction of the main body.

Preferably, the width direction of the barbs is vertical to the rolling direction of the material.

With the above technical scheme, the barbs can fix the friction material because the main body of the backing plate is provided with barbs with an inclination of less than 90° and can increase the adhesion strength of friction material when it is connected with friction material. Meanwhile, with the barbs, the strength of the backing plate is also increased, making the backing plate free of distortion, and increasing the performance of braking.

### BRIEF DESCRIPTION OF THE DRAWINGS

FIG. 1 is a stereoscopic schematic diagram of the Invention.

FIG. 2 is a locally enlarged schematic diagram of the Invention.

### DETAILED DESCRIPTION OF THE PREFERRED EMBODIMENTS

The Invention is further described in combination with Drawings and Embodiments as follows. It shall be noted that, these embodiments are for providing further understanding of the Invention, and do not form a restriction therefor. Moreover, the technical features related to the embodiments of the Invention described in the following can combine with each other when they are not conflicted with each other.

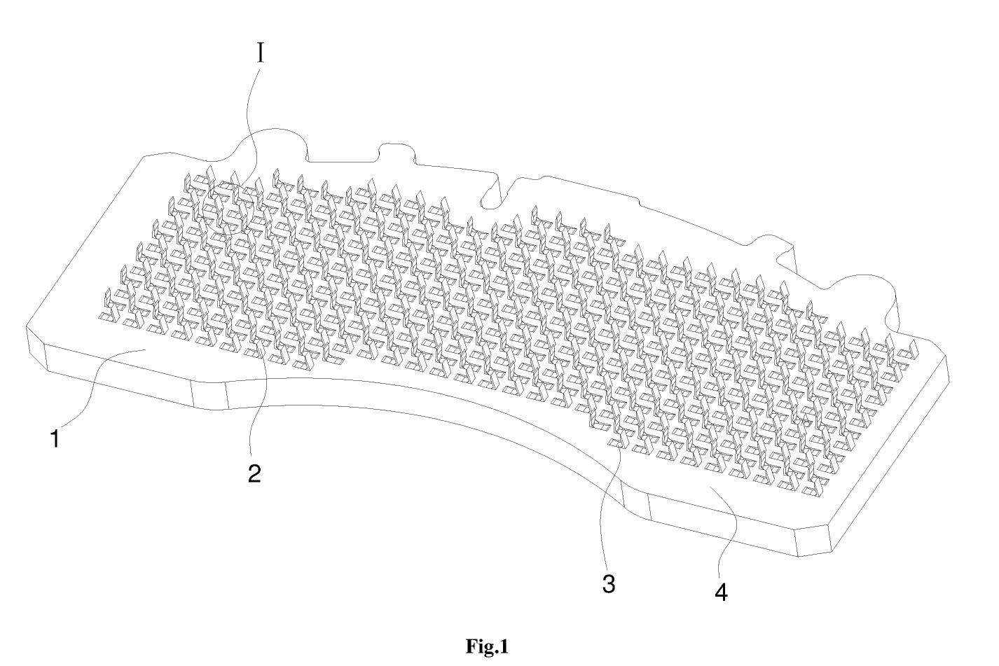

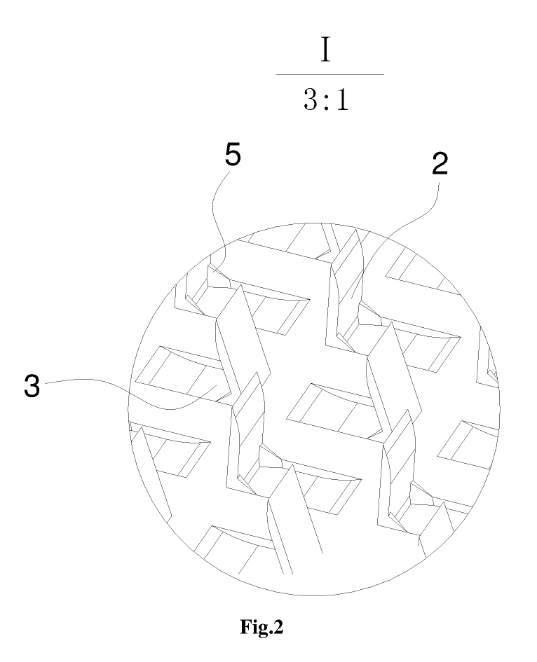

As shown in FIGS. 1 and 2, the reinforcing rib type barbed backing plate of brake pad comprises a main body 1, and the upper surface of the main body 1 is provided with inclined upward barbs 2 connected with friction material, and the inclination of the barbs 2 is less than 90°. In the embodiments of the Invention, the inclination of the barbs is 80°.

In this technical scheme, the barbs 2 are provided on the main body 1, and the inclination of the barbs 2 is 80°, so that the friction material will be applied with inclined downward pressure from the inner side of the barbs 2, effectively increasing the adhesion when it is connected with the friction material; barbs 2 may be formed mechanically on the main body 1 or formed by means of welding. In the embodiments of the Invention, barbs 2 are formed mechanically on the main body 1, i.e. barbs 2 are integrated with the main body 1 of the backing plate, and the barbs will have better strength and rigidity and the backing plate also has increased strength integrally, making backing plate not easily distorted, thus increasing performance of braking.

To further increase the adhesion of the friction material connected, in the embodiments of the Invention, the inner side of the root of the barbs 2 inclines and extends downwards to form grooves 3 lower than the upper surface, and the bottom of the grooves 3 inclines upward on the opposite side of the barbs 2 for transition to intersect with the upper surface 4. When connected, the friction material may be filled into the grooves 3, further increasing the adhesion of the friction material.

To increase the strength of the barbs 2, both sides of the root of the barbs 2 are provided with reinforcing ribs 5 connected with the upper surface 4.

To further integrally increase the adhesion of the friction material, in the embodiments of the Invention, the rows of the barbs 2 are set in different inclination directions, and the rows of the barbs are set at intervals and alternately in inclination direction. The barbs 2 are spaced evenly along the width direction of the main body.

To further increase the strength of the barbs and increase the shear force applied to the barbs, in the embodiments of the Invention, the width direction of the barbs 2 is vertical to the rolling direction of the material.

The above is a detailed description for the embodiments of the Invention in combination with drawings, but the embodiments of the Invention are not limited to it. For a person skilled in the art, various changes and amendments, replacements and deformations made under the premise of not departing from the spirit and essence of the Invention shall fall within the protection scope of the Invention.

1. A reinforcing rib type barbed backing plate of a brake pad for connection with a friction material, the barbed backing plate comprising a main body, and an upper surface of the main body is provided with inclined upward barbs adapted to be connected with the friction material, and the inclination of the barbs is less than 90°,
wherein both sides of the root of the barb are provided with reinforcing ribs connected with the upper surface.

2. The reinforcing rib type barbed backing plate of a brake pad for connection with a friction material according to claim 1, wherein, an inner side of the root of the barbs inclines and extends downwards to form grooves lower than the upper surface, and a bottom of the grooves inclines upward in an opposite side of the barbs for transition to intersect with the upper surface.

3. (canceled)

4. The reinforcing rib type barbed backing plate of a brake pad for connection with a friction material according to claim 3, wherein, inclination direction of rows of the barbs varies with that of the individual barbs, and the rows of the barbs are set at intervals and alternately in inclination direction.

5. The reinforcing rib type barbed backing plate of a brake pad for connection with a friction material according to claim 4, wherein, the barbs are spaced evenly along the width direction of the main body.

6. The reinforcing rib type barbed backing plate of a brake pad for connection with a friction material according to claim 5, wherein, the width section of the barbs is vertical to the rolling direction of the material.
